(19) United States
(12) Patent Application Publication
(10) Pub. No.: US 2014/0152791 A1
(43) Pub. Date: Jun. 5, 2014

(54) Mobile Device Biometric Sensor Apparatus

(71) Applicant: Shawn Jessee Sarwar, Washington, DC (US)

(72) Inventor: Shawn Jessee Sarwar, Washington, DC (US)

(21) Appl. No.: 13/690,546

(22) Filed: Nov. 30, 2012

(51) Int. Cl. H04N 5/374

(52) U.S. Cl. CPC H04N 5/374
USPC 348/77

(57) ABSTRACT

A biometric sensor apparatus uses an infra-red light source and a CMOS image sensor attached to or built into a wireless mobile phone to allow the mobile phone's CMOS image sensor to capture biometric images, specifically but not limited to a finger print. In one embodiment, the apparatus includes a light source and sensors, and a mobile phone having complementary logic to process emitted light reflected off a user's finger into an input finger print. Digital processing of the collected image signal data is performed, such as by smoothing.

### FIELD OF INVENTION

The present invention relates to a mobile device biometric sensor apparatus. More particularly, but not exclusively, it relates to a mobile device biometric sensor apparatus for capturing finger print images using a mobile device's built in CMOS camera without additional sensors.

### BACKGROUND OF THE INVENTION

In the field of biometrics, fingerprint scanners are but one device that is used to uniquely identify and verify the identity of an individual. Presently, fingerprint scanners are standalone devices that must be integrated into other electronic devices in order for them to work. Some such devices attach to a mobile device directly through USB or other connection method.

Modern advances in microprocessor and telecommunications technology have led to the increase proliferation, availability, and adoption of mobile devices both in developed nations and developing nations. Currently, developing nations are seeing rapid expansions in the use of mobile devices. As these devices increase in power and functionality, features such as a CMOS camera have gone from being a luxury option to a commonplace feature even on the most basic of modern mobile devices.

However, there have been no attempts to utilize the built in CMOS camera that are now a standard feature of many mobile devices. There is therefore a need for a device and a method of obtaining biometric information that combines the technology of peripheral fingerprint scanners with the increased processing power and image integrity available in current mobile devices.

### SUMMARY OF THE INVENTION

The present invention discloses a reduced cost, easy to use portable fingerprint reader. The inventive devices thereof for using can be standalone or can be coupled to a network. The inventive apparatus allows for decreased cost, increased versatility, and the possibility of wide availability both in developed countries and developing countries. With the present invention, anyone who has an electronic device, such as a mobile phone, with a built in camera and an internal processor, can add the capability of capturing accurate fingerprints anywhere and anytime. Once a fingerprint is captured, it could be uploaded into a database or it could be used to verify identity for access to sensitive information such as medical records, financial records, work documents, voting ballots and the like. The inventive apparatus could be used in conjunction with a worldwide database that could store a variety of medical information, such as vaccine information, last date of tetanus, and virtually any other piece of medical information of an individual.

Law enforcement personnel could use the present device in the field if for example during a routine police stop they wanted to determine if the person(s) being detained had outstanding warrants. The ability to use relatively low to no cost cell phones to replace the need to purchase a whole system is a significant cost savings for a consumer or organization. In developing countries, computers are still not common (and extremely expensive) while cell phones are common place and rapidly growing.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a prospective view of a wireless mobile phone incorporated with the teachings of the present invention, in accordance with one embodiment;

FIG. 2 illustrates a cut away side view of one embodiment of the disclosed invention; and

FIG. 3 illustrates a cut away side view of one embodiment of the disclosed invention which includes anticipated light path and reflection from light source to image capture.

### DETAILED DESCRIPTION OF THE INVENTION

The invention described herein is not limited in its application to the details of construction and the arrangements of the components set forth in the following description or illustrations in the accompanying figures. The invention is capable of other embodiments and of being practiced or carried out in various ways. The phraseology and terminology used herein is for the purpose of description and should not be regarded as limiting. The use of “including” and “comprising” and variations thereof is meant to encompass the items listed thereafter and equivalents thereof as well as additional items. The use of “consisting of” and variations thereof herein is meant to encompass only the items listed thereafter. The use of letters to identify steps of a method or process is simply for identification and is not meant to indicate that the steps should be performed in a particular order. Moreover, the use of gender specific pronouns is not meant to exclude either gender from the benefits provided by the present invention.

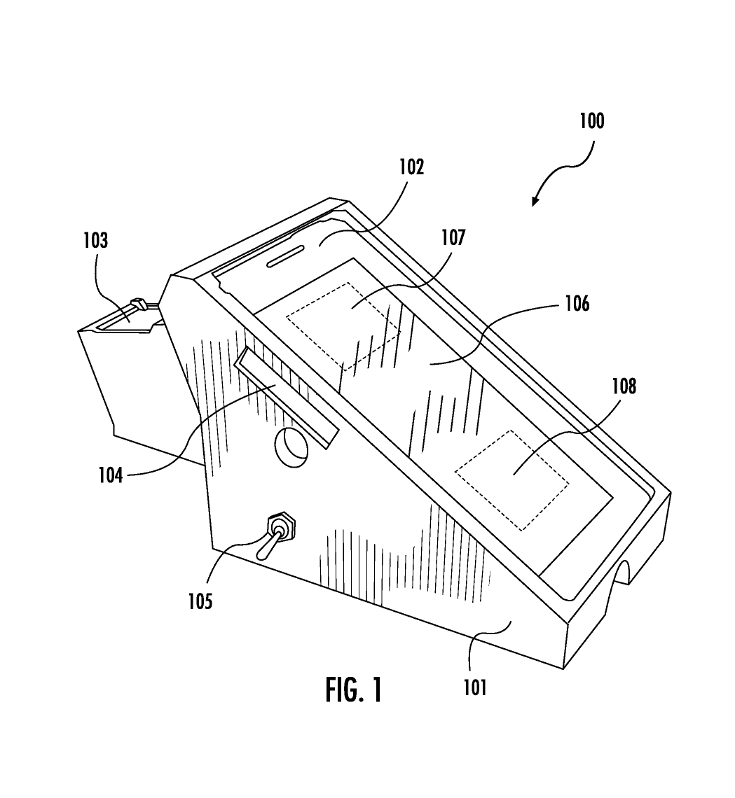

Turning to the present invention, FIG. 1 shows a first embodiment of a biometric sensor apparatus 100. Those skilled in the art will recognize that the shape and size of the biometric sensor apparatus 100 could be altered without changing the functionality of the present invention. This particular embodiment of a biometric sensor apparatus 100 includes a housing, 101 for securing an electronic device 102. The housing 101 can have many alternative embodiments with varying configurations that best secure a particular electronic device 102. Typically, the housing 101 is designed to allow the electronic device 102 to rest securely within the housing 101. The exact location and configuration of the components is dependent on the location of the built-in camera 107, and more specifically designed to ensure proper optical coupling between the prism 103 and the electronic device 102.

The electronic device includes an internal camera 107 and processor 108. In one embodiment, the electronic device could be a cellular phone such as those presently available to consumers, e.g., iPhone, Android, and the like. Those skilled in the art will recognize that these cellular telephones, along with most smart phones have built-in cameras 107 as well as internal processors 108.

The internal camera 107 in this particular embodiment has an autofocus feature and is capable of achieving a resolution of at least 250 dots per inch. Moreover, the camera 107 in this embodiment may optionally have a built-in flash feature used to add light prior to a photograph being taken in the event that the processor 108 detects that there is not enough light for the camera to take a clear photograph. Additional optional features for the camera 107 include: a light sensitive device, which could be a complementary metal-oxide semiconductor (CMOS) image sensor or a charge coupled device (CCD). In this embodiment, the camera 107 would be capable of capturing an image with an image quality of at least 250 dots per inch (DPI) and a maximum focal length of eight inches.

The electronic device 102 is optically coupled to a prism 103, which is also secured within the housing 101. Those skilled in the art will recognize that alternate embodiments of the housing 101 could be different shapes or sizes, and could even be comprised of two or more pieces joined together, so long as the proper optical coupling between the prism and the electronic device 102 remained. If, for example, the housing 101 was made of two or more pieces joined together, the user may more easily secure the electronic device to the housing 101. This embodiment allows the further advantage of providing internal access to the housing 101 and any internal devices therein.

The electronic device 102 is adapted to receive optical information from the prism 103. When optical information is received by the electronic device 102, the processor 108 converts that information into a fingerprint using internal software, which could, for example, be stored on the phone as an app. The internal software used to process the optical information can be either custom made or off-the-shelf software. The optical information received by the electronic device 102 will be able to be corrected by the software running on the processor 108, for any possible image distortion that results from the optical coupling of the electronic device 102 and the prism 103. In one embodiment, the software would correct any image distortion to adjust the perceived perspective from an arbitrary angle to a direct view. This correction method is non-claimed and is an example of basic digital correction that software which could be easily ran on the processor 108 of the electronic device 102, would be able to be perform. Any digital optical correction or adjustment can be made by the software both automatically, prior to presenting the user with the image, and/or at the user's direction.

Typically the prism 103 is transparent. The prism 103 can be shaped so as to allow an individual to place his finger on the prism 103 so that an image can be rendered of his fingerprint. Similarly, in an alternate embodiment, the prism 103 could be concave.

In the embodiment of FIG. 1, the biometric sensor apparatus 100 has a cavity 104 that allows a user access to buttons or other control mechanisms on the electronic device 102. Those skilled in the art will recognize that additional cavities 104 could be incorporated into the housing 101, for example where the power button or charging portion of the electronic device reside. This embodiment further includes a switch 105 coupled to a light source 125.

In this embodiment, the screen 106 of the electronic device could be used to render the fingerprint once the processor 108 has completed its processing of the optical data. The processor 108 of the electronic device 102 is further capable in this embodiment of achieving network connectivity to a network, e.g., the world wide web. In this embodiment, processed fingerprint data could be uploaded or downloaded to suit a user's preference. This type of data transmission is well known in the art.

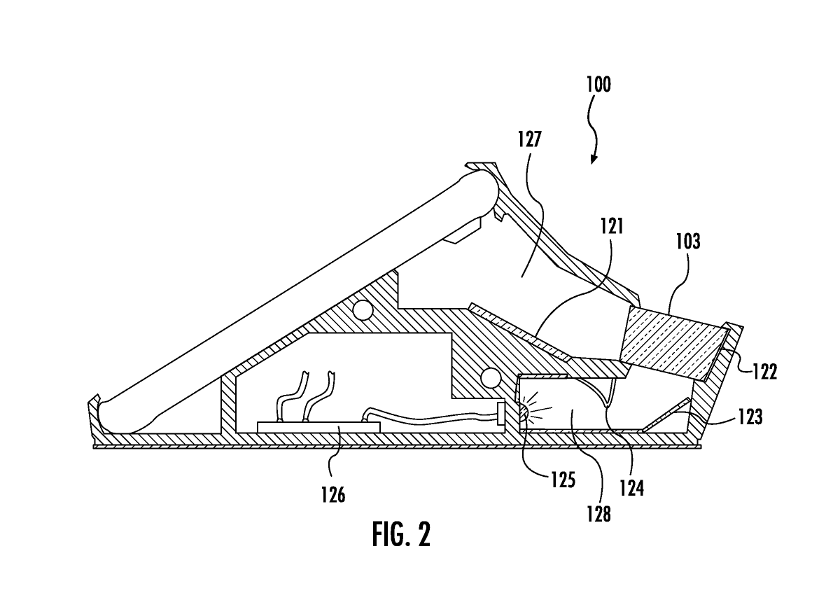

FIG. 2 shows a cutaway of the biometric sensor apparatus 100. This view shows features internal to the housing 101 of the present invention. Specifically, these additional features include a minor 121, an internally reflective face 122 of the prism 103, reflective surface 123, a baffle 124, a light source 125, and a power source 126 that is coupled to the switch 105.

In a preferred embodiment the mirror 121 is no more than fifty percent absorptive and could be a first surface minor. In a preferred embodiment the prism 103 is secured by the housing 101 to allow a finger to be placed proximal to an exposed surface of the prism 103, wherein said prism 103 is cut at angles that establish internal reflective geometry that allow for the camera 107 to capture a reflection off of the mirror 121.

In FIG. 2, the light source 125 could be a light emitting diode or similar light generating device. In an alternate embodiment, the light source 125 could be a flash built into the electronic device 102. In one embodiment, the light source 125 could be a red LED. A user of the present invention can decide whether she wants to use the built-in flash of the electronic device 102 of a light source 125 contained within the housing 101. If the user desires to use the light source 125, the power source 126 is used to power the light source 125. Additionally, the user could control whether a light source 125 or the internal flash in the electronic device 102 is used by using the switch 105. If the switch 105 is positioned so as to choose the light source 125 as the source of light, then the power source 126 is activated and power is provided to the light source 125. If the user desires to use the internal flash of the electronic device 102, then the light source 125 will not receive any power. In an alternate embodiment, the internal flash of the electronic device 102 could be connected to a fiber optic cable that allows for the channeling of the light to illuminate the prism 103 in a manner consistent with allowing the camera 107 to capture an image of a fingertip. Irrespective of whether the user decides to use a flash built into the electronic device 102 or a light source 125, the light produced by either of these options and equivalents known to those skilled in the art is capable of illuminating the prism 103.

In one embodiment the power source 126 could be a battery. In an alternate embodiment, the power source 126 could be a battery coupled to a resistor.

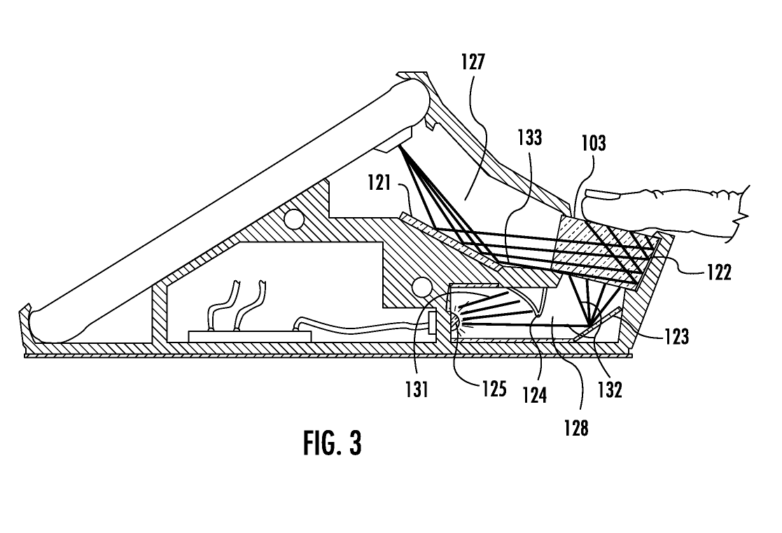

Reference is made to FIG. 3 which shows the path of the light through the biometric sensor apparatus from the light source 125 to the camera 107. In an embodiment the light source 125 consists of an LED, from which light is projected in two paths, light path A 131 and light path B 132. These two paths are contained within a first chamber 127 and second chamber 128. The advantage of this embodiment is that it allows greater control of the amount of light that reaches the prism. In one embodiment, the first chamber 127 may include the camera 107, a minor 121, and one face of the prism 103. In this embodiment, the second chamber 128 could include the light source 125 and another face of the prism 103.

The light in path A 131 is projected toward a baffle 124 that prevents the direct path of light to the prism 103 and an opening with reflective surface 123. The baffle 124, which can be made out of the same reflective surface material, acts to block the direct light path A 131. The baffle 124 allows only light from light path B 132 to reflect off of the reflective surface 123 positioned to reflect the light on light path B 132 towards the prism 103 onto the face of the prism 103 that is opposite the top face of the prism 103 acting as the flat surface 103 on which a fingertip is placed. In one embodiment, the reflective surface can be made of reflective tape.

The prism 103 is then filled with light from light path B 132. Upon a fingertip being pressed on the top face of the prism 103, total internal reflection becomes frustrated by the presence of the finger's ridges in contact with the surface of the prism 103. The light inside of the prism 103 reflects off the ridges of the fingertip onto the far right internally reflective face 122 of the prism 103 which is mirrored. The light is transmitted along light path C 133 to the next chamber where it is reflected by the mirror 121 into the camera 107. Those of skill in the art will recognize that the positioning of an internally reflective face 122 of the prism 103 could be altered from what is depicted in FIG. 3 in order to properly reflect light from the prism 103 to the camera 107.

Additionally, a cavity 104 allows for the manipulation of the buttons on the side of the electronic device 102. In the present embodiment a control switch 105 is located on the exterior of the biometric sensor apparatus 100 to allow a user to control the internal light source. The control switch 105 can be located on any exterior part of the biometric sensor apparatus 100.

What is claimed is:

1. An apparatus for capturing biometric information comprising:
a housing suited for securing an electronic device, wherein said electronic device includes a camera having a resolution of at least two hundred and fifty dots per inch;
at least one minor;
a light source positioned to illuminate said mirror;
a prism; and
a power source. The apparatus of claim 1, wherein said camera comprises a complementary metal-oxide semiconductor (CMOS) image sensor. The apparatus of claim 1, wherein said camera comprises a charge coupled device (CCD) image sensor. The apparatus of claim 1, wherein the camera has an automatic focus feature. The apparatus of claim 1, wherein said light source comprises an electronic flash. The apparatus of claim 5, wherein said flash is connected to a fiber optic cable. The apparatus of claim 1, wherein said light source comprises at least a single light emitting diode (LED) that is capable of illuminating the prism. The apparatus of claim 7, wherein the at least a single light emitting diode (LED) is a shade of red in color. The apparatus of claim 1, where said mirror is no more than fifty percent absorptive. The apparatus of claim 1, wherein the mirror is a first surface mirror. The apparatus of claim 1, wherein the prism has an internal facing reflective face on at least one side. The apparatus of claim 1, wherein the prism further comprises a slightly concave surface. The apparatus of claim 1, wherein said apparatus further comprises a reflective surface positioned between the light source and the prism. The apparatus of claim 13, wherein said reflective surface comprises reflective tape. The apparatus of claim 1, wherein said apparatus further comprises a baffle positioned between the light source and the prism. The apparatus of claim 15, wherein the baffle is reflective. The apparatus of claim 1, further comprising a first chamber and a second chamber separated by the prism.
